(19) United States
(12) Patent Application Publication
(10) Pub. No.: US 2012/0171941 A1
(43) Pub. Date: Jul. 5, 2012

(54) SUBSTRATE PROCESSING APPARATUS AND SUBSTRATE PROCESSING METHOD

(75) Inventor: Minoru Matsuzawa, Tokyo (JP)

(73) Assignee: MICRO ENGINEERING INC., Tokyo (JP)

(21) Appl. No.: 13/334,343

(22) Filed: Dec. 22, 2011

(30) Foreign Application Priority Data
Dec. 22, 2010 (JP) 2010-286450

(51) Int. Cl. B08B 15/02

(52) U.S. Cl. 454/56

(57) ABSTRACT

By exhausting a gas in a second space (S2) surrounded by an outer wall of an inner barrel member (12) and an inner wall of an outer barrel member (13) outside an outer wall of the outer barrel member (13), a pressure in the second space (S2) is decreased so as to be lower than a pressure in a first space (S1) in the inner barrel member (12). This enables the gas in the first space (S1) to pass through a communication mechanism (30) and flow toward the second space (S2). At this time, an airflow passing through the communication mechanism (30) is “narrowed” so that the airflow is forced to flow. Thus, a mist containing particles or the like, which is generated when performing processing of the substrate (20), is efficiently exhausted from the first space (S1), therefore, contamination of the processing target surface of the substrate is prevented.

### BACKGROUND OF THE INVENTION

1. Field of the Invention

The present invention relates to a substrate processing apparatus for performing surface processing with a processing liquid such as pure water or a chemical liquid with the use of a table which rotates in a horizontal direction under a state in which a substrate such as a semiconductor wafer or a glass substrate is supported and to a substrate processing method.

2. Description of the Related Art

In a photoresist step as one of semiconductor manufacturing steps, generally, a processing target surface of a semiconductor wafer or a glass substrate (hereinafter, simply referred to as “substrate”) is etched and cleaned, and after being exposed in a predetermined pattern, wetted with a chemical liquid to form a resist pattern. After that, in order to remove a dissolved material of a resist together with a developer from the substrate surface, surface processing such as cleaning the substrate surface with pure water and the like is performed.

To give an example, in a processing apparatus including a rotatable table, a center of a rotational axis of the table and a center of a substrate to be subjected to processing are coincident with each other, and under a state in which the substrate is placed horizontally, a processing liquid such as pure water or a chemical liquid is supplied in the vicinity of a center portion of the table, that is, in the vicinity of a center portion of the substrate. Then, the processing liquid is forced to flow by centrifugal force to be spread on the entire processing target surface of the substrate. Thus, the surface processing is proceeded.

However, in such kind of conventional processing apparatus, the processing liquid is supplied while the table is rotated at high speed, and hence a mist containing particles or the like spreads in a processing space including the table, which causes a problem that the mist adheres to the processing target surface of the substrate or that the surface of the substrate after processing is contaminated. Further, when the chemical liquid to be used in the processing has a corrosive property, the chemical liquid becomes a mist to spread and adhere to a drive portion or a delivery portion of the processing apparatus, which causes a problem that the durability of those portions is reduced.

From a viewpoint of preventing the mist from adhering to the processing target surface, there is an apparatus disclosed in Japanese Patent Application Laid-open No. 2005-79220. In this apparatus, a drooping cylindrical rectifying member is provided to a processing container for performing processing, and a spread mist is exhausted from an upper exhaust port, which is provided through the side wall of the processing container so as to be opposed to the rectifying member.

In an apparatus disclosed in Japanese Patent Application Laid-open No. 2009-59795, airflow control means which freely ascends and descends relatively to the table is provided. By adjusting a gap between the airflow control means and the table while measuring an external pressure value and an internal pressure value to control the flow-in amount of the airflow, an atmosphere once discharged to be stored in a cup is prevented from leaking outside the cup again.

The apparatus disclosed in Japanese Patent Application Laid-open No. 2005-79220 has a structure of exhausting the mist also from the upper exhaust port. With this, however, equipment having high exhaust processing performance becomes necessary, which leads to increase in cost. Further, the mist containing particles or the like adhering to the rectifying member is not removed and remains thereon, and hence the mist falls onto the processing target surface of the substrate in a certain stage, and thus the substrate is contaminated in some cases.

Further, the apparatus disclosed in Japanese Patent Application Laid-open No. 2009-59795 has a complex structure, and hence the burden of the manufacturing cost increases. Further, the mist containing particles or the like adhering to the airflow control means is not removed and remains thereon, and hence, as described above, the mist falls onto the processing target surface of the substrate in a certain stage, and thus the substrate is contaminated in some cases.

### SUMMARY OF THE INVENTION

The present invention has been made to solve the above-mentioned problems, and has a main object to provide a substrate processing technology which is capable of efficiently exhausting a gas in a processing space for substrate processing, and preventing deposition of a mist containing particles or the like, which contaminates the substrate.

In order to solve the above-mentioned problems, the present invention provides a substrate processing apparatus and a substrate processing method.

The substrate processing apparatus according to the present invention includes: a bottomed double barrel member including an inner barrel member and an outer barrel member, the inner barrel member including a first space in which a substrate to be subjected to processing is to be arranged; exhaust means for exhausting a gas in a second space surrounded by an outer wall of the inner barrel member and an inner wall of the outer barrel member outside an outer wall of the outer barrel member from the second space; a communication mechanism which is formed in a predetermined part of the inner barrel member, for communicating the first space and the second space with each other; a table for horizontally supporting the substrate on a front surface side thereof inside the first space in the inner barrel member so that a front surface side of the substrate becomes a processing target; and table ascending/descending means for causing the table to move so that the table freely ascends and descends in the first space, in which the exhaust means exhausts the gas in the second space outside the outer wall of the outer barrel member from the second space to decrease a pressure in the second space so that a pressure in the first space becomes higher than the pressure in the second space, thereby forcing a gas in the first space to flow when flowing through the communication mechanism toward the second space, the gas in the first space flowing through a gap between an outer end surface of the table, which one of ascends and descends in the first space, and an inner wall of the inner barrel member, the gas in the first space being forced to flow when flowing from the front surface side of the table to a rear surface side of the table so as to pass through the gap.

In this substrate processing apparatus, the gas in the second space of the chamber corresponding to the bottomed double barrel member is discharged outside the outer wall of the outer barrel member, to thereby decrease the pressure in the second space so that the pressure in the first space becomes higher than that in the second space. In this manner, the gas in the first space on the front surface side of the table is caused to pass through the communication mechanism and flow toward the second space. When passing through the communication mechanism, the airflow is “narrowed, and hence owing to the Venturi effect, the flow (airflow) is forced to flow. With this, the mist containing particles or the like, which is generated when processing the substrate, can be efficiently exhausted from the first space. Thus, contamination of the substrate is prevented. Further, the gas is not randomly dispersed from the first space, and hence it is possible to prevent adverse effects on human health due to the gas, and corrosion of the equipped components of the substrate processing apparatus. Still further, the opening portion of the inner barrel member also “narrows” the airflow directed toward the first space, and hence owing to the Venturi effect, the airflow is further forced to flow, to thereby obtain a good downward flow.

Further, in the substrate processing apparatus, the exhaust means exhausts the gas in the second space outside the outer wall of the outer barrel member from the second space to decrease the pressure in the second space so that the pressure in the first space becomes higher than the pressure in the second space, thereby forcing a gas in the first space on the front surface side of the substrate to flow when flowing toward the second space so that the gas passes through the communication mechanism.

With this, in the first space, the mist containing particles or the like above the processing target surface of the substrate supported so that the front surface side of the substrate is the processing target is efficiently exhausted from the first space, and hence it is possible to prevent the contamination of the processing target surface of the substrate more effectively.

Further, in the substrate processing apparatus, when the gas in the first space flows through the communication mechanism toward the second space, the gas in the first space flowing through a gap between an outer end surface of the table, which one of ascends and descends in the first space, and an inner wall of the inner barrel member is forced to flow when flowing from the front surface side of the table to a rear surface side of the table so as to pass through the gap.

With this, the gas in the first space flows through the gap from the front surface side of the table toward the rear surface side of the table to be exhausted outside the outer wall of the outer barrel member. This gap “narrows” the airflow, and hence owing to the Venturi effect, the airflow is further forced to flow. Therefore, when the table ascends or descends, the airflow thus forced to flow enables efficient removal of, from the inner wall of the inner barrel member, the mist containing particles or the like adhering to the inner wall in a range that the table ascends or descends. With this, it is possible to prevent deposition of the mist containing particles or the like onto the inner wall of the inner barrel member, which contaminates the processing target surface of the substrate.

According to a further aspect of the present invention, the table is disposed inside the inner barrel member so as to be rotatable in parallel to a processing target surface of the substrate under a state in which the processing target surface is exposed to the first space, the substrate is one of supported onto and released from the table under a state in which the table is stopped at an opening portion of the inner barrel member, and the table ascending/descending means causes the table supporting the substrate before the processing to descend from the opening portion of the inner barrel member and then causes the table to stop the descending, and further, causes the table supporting the substrate after the processing to ascend up to the opening portion of the inner barrel member and then causes the table to stop the ascending.

In this substrate processing apparatus, the table stops at the opening portion of the inner barrel member, to thereby “lid” the opening portion. In this manner, the gas in the first space and the gas in the second space are prevented from passing through the opening portion to flow outside the processing space.

According to a still further aspect of the present invention, the exhaust means exhausts the gas in the second space outside the outer wall of the outer barrel member via an exhaust duct provided in the outer wall of the outer barrel member in parallel to a tangential direction of the outer wall of the outer barrel member, and when the exhaust means exhausts the gas in the second space outside the outer wall of the outer barrel member, the exhaust duct generates an airflow rotating along the inner wall of the outer barrel member, and the gas in the second space is forced to flow by the airflow, to thereby be exhausted outside the outer wall of the outer barrel member.

With this, the gas in the second space is forced to flow by the centrifugal force of the airflow rotating inside the second space, and hence it is possible to enhance the exhaust efficiency. Further, the gas in the second space is efficiently exhausted outside the outer wall of the outer barrel member, and hence the gas in the first space also flows toward the second space more efficiently. Therefore, the exhaust efficiency in the first space is also enhanced.

From a viewpoint of collecting a used processing liquid that has been used for the processing of the substrate, the substrate processing apparatus further includes a gutter provided in the second space, for collecting a used processing liquid that has been used for the processing of the substrate and has passed through the communication mechanism, the gutter covering the communication mechanism from the outer wall side of the inner barrel member, in which: the gutter is provided with a blocking wall for blocking one of a part and a whole of the communication mechanism from the outer wall side of the inner barrel member, to thereby limit the passing of the gas in the first space through the communication mechanism; and the substrate processing apparatus further includes gutter ascending/descending means for causing the gutter to one of ascend and descend along the outer wall of the inner barrel member so that the blocking wall blocks the one of the part and the whole of the communication mechanism.

In this substrate processing apparatus, by blocking the part or the whole of the communication mechanism with the blocking wall, the airflow passing through the communication mechanism can be limited. With this, by blocking the part of the communication mechanism with the blocking wall to limit the airflow passing through the communication mechanism, for example, a force can be applied to the airflow corresponding to the viscosity of the processing liquid to be used, and thus the “cutoff” of the processing liquid which is spun off from the processing target surface of the substrate can be made satisfactorily uniform. Further, by blocking the whole of the communication mechanism with the blocking wall and blowing a nitrogen or clean dry air (CDA) gas from the opening portion of the inner barrel member, the first space may be formed into a nitrogen atmosphere or a CDA atmosphere. Further, by blocking the whole of the communication mechanism with the blocking wall, the gas in the second space can be prevented from flowing out to the first space.

According to a yet further aspect of the present invention, the gutter is provided with a barrier wall for reducing a moving speed of the used processing liquid entering the gutter and moving through the gutter, and the used processing liquid entering the gutter and moving through the gutter hits onto the barrier wall to slow down andbe collected by the gutter, and further, the gas in the first space entering the gutter passes through the gutter to flow out to the second space.

The used processing liquid entering the gutter and moving through the gutter hits onto the barrier wall provided to the gutter and loses its momentum. Then, due to the action of gravity, the used processing liquid moves downward to be collected in the gutter. Further, the gas in the first space entering the gutter passes through the gutter to flow out to the second space. With this, the airflow entering the gutter does not generate a disturbed flow in the gutter, which agitates the used processing liquid entering the gutter. Thus, the collecting efficiency of the used processing liquid is enhanced.

According to a yet further aspect of the present invention, the gutter for collecting the used processing liquid includes a plurality of stages in an ascending and descending direction so that a plurality of types of the used processing liquid, which have been used for the processing of the substrate, are independently collected, and the gutter ascending/descending means causes the gutter to one of ascend and descend along the outer wall of the inner barrel member so that, in order to collect different types of the used processing liquid in the respective plurality of stages, a stage corresponding to the used processing liquid to be collected covers the communication mechanism.

With this, even when the plurality of types of the processing liquid are used in one substrate processing, the used processing liquid to be collected can be independently collected. Further, it becomes unnecessary to clean the gutter, which has been performed every time the used processing liquid to be collected changes. Thus, it is possible to perform efficient substrate processing.

According to a yet further aspect of the present invention, the bottomed double barrel member of the substrate processing apparatus is formed of a translucent member. With this, it is possible to visually observe the processing status of the substrate from the exterior appearance of the bottomed double barrel member, and hence, for example, it is possible to rapidly discover the apparatus failure occurring in the middle of the substrate processing, or the breakage of the substrate during processing.

According to the present invention, there is provided a substrate processing method for a substrate processing apparatus capable of exhausting a gas in a processing space for performing processing of a substrate, the substrate processing apparatus including a bottomed double barrel member including an inner barrel member and an outer barrel member, the inner barrel member including a first space in which the substrate to be subjected to the processing is to be arranged, the substrate processing method including: exhausting, by exhaust means, a gas in a second space surrounded by an outer wall of the inner barrel member and an inner wall of the outer barrel member outside an outer wall of the outer barrel member from the second space, to thereby decrease a pressure in the second space so that a pressure in the first space in the inner barrel member becomes higher than the pressure in the second space; and forcing a gas in the first space to flow when flowing through a communication mechanism toward the second space, the communication mechanism being formed in a predetermined part of the inner barrel member, for communicating the first space and the second space with each other, the gas in the first space flowing, when a table for horizontally supporting the substrate on a front surface side thereof inside the first space in the inner barrel member so that a front surface side of the substrate becomes a processing target one of ascends and descends in the first space by table ascending/descending means, through a gap between an outer end surface of the table and an inner wall of the inner barrel member, the gas in the first space being forced to flow when flowing from the front surface side of the table to a rear surface side of the table so as to pass through the gap.

According to the present invention, it is possible to efficiently exhaust, to the outside, the gas in the processing space for the substrate processing, and effectively prevent the deposition of the mist containing particles or the like, which contaminates the substrate.

### BRIEF DESCRIPTION OF THE DRAWINGS

In the accompanying drawings:

FIG. 1 is a schematic vertical sectional view of a substrate processing apparatus according to a first embodiment of the present invention;

FIG. 2 is a schematic plan view of the A-A portion of FIG. 1;

FIG. 3 is a schematic vertical sectional view of the substrate processing apparatus, illustrating a table position when a substrate is carried in and out;

FIG. 4 is a schematic vertical sectional view illustrating a moving state of an airflow and a processing liquid when the substrate is subjected to processing;

FIG. 5 is a schematic vertical sectional view illustrating the airflow when the table descends;

FIG. 6 is a schematic vertical sectional view illustrating the airflow when the table ascends;

FIG. 7 is a schematic vertical sectional view illustrating a state in which a used processing liquid is collected by a multistage gutter, together with a moving state of the airflow and the processing liquid;

FIG. 8 is an explanatory flow chart illustrating an overall procedure of a substrate processing method to be executed in the substrate processing apparatus;

FIG. 9 is a schematic vertical sectional view of a substrate processing apparatus according to a second embodiment of the present invention;

FIG. 10 is a schematic plan view of the substrate processing apparatus of the second embodiment;

FIG. 11 is a schematic vertical sectional view of the substrate processing apparatus, illustrating a table position when a substrate is carried in and out and a state of a multistage gutter; and

FIG. 12 is a schematic vertical sectional view illustrating a state in which a used processing liquid is collected by the multistage gutter, together with a moving state of the airflow and the processing liquid.

### DETAILED DESCRIPTION OF THE PREFERRED EMBODIMENTS

A substrate processing apparatus according to the present invention is an apparatus for performing processing on a substrate such as a semiconductor wafer or a glass substrate, with the use of a chemical liquid, a cleaning liquid, or other such liquid (processing liquid). This substrate processing apparatus has a main feature in a chamber structure, which is capable of forming a suitable airflow for preventing, for example, a used processing liquid or a mist containing particles from adhering to a processing target surface of the substrate and preventing contamination of the substrate surface. In the following, embodiments of the substrate processing apparatus are described with reference to an example of an apparatus including a table which rotates in parallel to the processing target surface under a state in which the processing target surface is supported horizontally, the processing target surface corresponding to one surface of the substrate to be subjected to processing such as cleaning and drying, in which the processing liquid is supplied toward the processing target surface on the table.

### First Embodiment

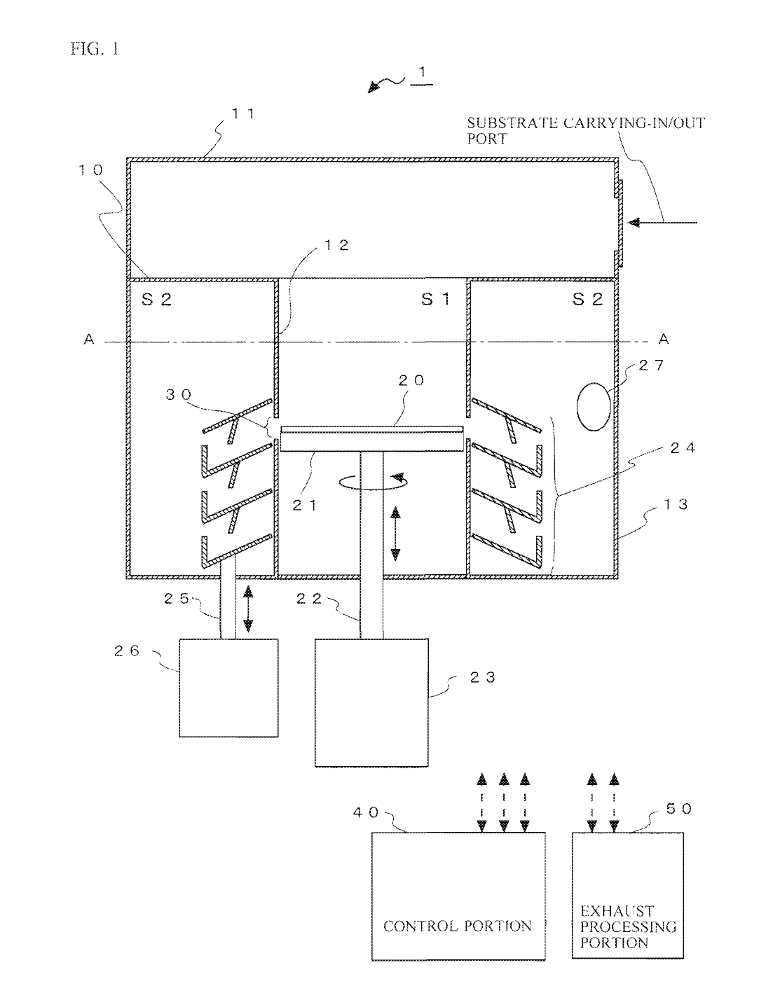

FIG. 1 is a schematic vertical sectional view illustrating a structural example of periphery members of a substrate processing apparatus 1 according to a first embodiment of the present invention.

The substrate processing apparatus 1 illustrated in FIG. 1 includes a chamber 10 formed of a bottomed double barrel member including an inner barrel member 12 and an outer barrel member 13, and a top cover 11. A space formed by the chamber 10 and the top cover 11 serves as a main processing space for performing various processing on a substrate 20.

A bottomed barrel member refers to a barrel member with an upper bottom portion thereof being opened and a lower bottom portion thereof being provided continuously to a side wall thereof. The bottomed double barrel member refers to a member with an inner barrel member being arranged inside an outer barrel member. Note that, the shape of the barrel member may be cylindrical as well as polygonal.

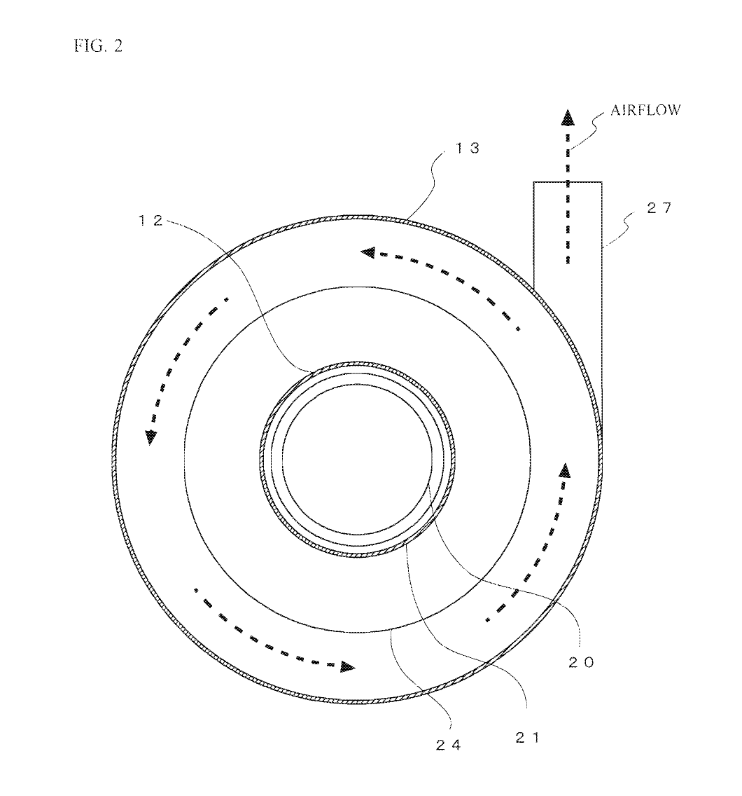

As an example of the shapes of the inner barrel member 12 and the outer barrel member 13 of the chamber 10, cylindrical barrel members are illustrated in FIGS. 1 and 2. In an outer wall of the chamber 10, an exhaust duct 27 is provided, which is described in detail later.

The substrate processing apparatus 1 mainly includes a motor 23 having an actuator function for rotating a table 21 and causing the table 21 to ascend or descend, a multistage gutter 24 for collecting a used processing liquid which has been used in substrate processing, an actuator 26 for causing the multistage gutter 24 to ascend or descend, and a control portion 40 including a computer for controlling the motor 23, the actuator 26, an exhaust processing portion 50, a processing liquid supply mechanism (not shown) for supplying a processing liquid to a processing target surface of the substrate 20, and a chuck mechanism (not shown) for supporting the substrate 20 onto the table 21.

In order to enable rotation of the table 21 in a first space inside the inner barrel member 12 (hereinafter, also referred to as S1 space in some cases), a predetermined gap is provided between an inner wall of the inner barrel member 12 and an opposed outer end surface of the table 21. The predetermined gap refers to a gap between the outer end surface of the table 21 and the opposed inner barrel member 12 of, for example, about 2 mm. By adjusting the distance of the gap, it is possible to increase or decrease the force to be applied to the airflow described later. One end of the inner barrel member on the top cover 10 side is opened (opening portion).

At a predetermined part of the inner barrel member 12, there is formed a communication mechanism 30 for communicating the S1 space and a second space (hereinafter, also referred to as S2 space in some cases) surrounded by an outer wall of the inner barrel member 12 and an inner wall of the outer barrel member 13.

The processing liquid supplied at the time of processing of the substrate 20 moves on the processing target surface of the substrate 20 and then is spun off from the processing target surface. Then, the used processing liquid thus spun off passes through the communication mechanism 30 so as to be collected by the multistage gutter 24 described later. Therefore, the communication mechanism 30 is formed into an arbitrary shape and size at a part of the inner barrel member 12 at which the used processing liquid spun off from the processing target surface adheres (collides) to the inner barrel member 12.

The arbitrary shape and size refer to, for example, a shape of a band with a width of about 40 mm, which surrounds the inner wall of the inner barrel member 12 mainly at a part of the inner barrel member 12 at which the used processing liquid spun off from the processing target surface adheres (collides) to the inner barrel member 12, and a size that the surrounded portion is opened by about 80%. As another example, the above-mentioned surrounded range may be entirely opened so that the inner barrel member 12 is divided into two upper and lower parts which sandwich the communication mechanism 30 formed in the inner barrel member 12.

By passing through the communication mechanism 30, a gas in the S1 space flows out to the S2 space. Examples of the gas include a mist of the used processing liquid which has been used for processing of the substrate 20, a mist containing particles, the used processing liquid formed into a gas, and the like.

The top cover 11 is provided with a substrate carrying-in/out port for carrying-in the substrate 20 before processing from outside the processing space of the substrate processing apparatus 1 to the processing space, and for carrying-out the substrate 20 after processing from the processing space of the substrate processing apparatus 1 to outside the processing space. A space surrounded by the top cover 11 forms a part of the above-mentioned processing space. The processing of the substrate 20 is performed under a state in which the substrate carrying-in/out port is closed, and hence the mist of the processing liquid or the processing liquid formed into a gas, which is generated in the processing space, does not flow outside the processing space. The space surrounded by the top cover 11 is supplied with clean air by a clean air supply mechanism (not shown).

The multistage gutter 24 includes a plurality of stages in an ascending and descending direction so that a plurality of types of the used processing liquid, which are used for processing of the substrate 20, can be independently collected. Therefore, in order to collect different used processing liquid in each stage, the multistage gutter 24 ascends or descends along the outer wall of the inner barrel member 12 by being controlled by the control portion 40 so that the stage corresponding to the used processing liquid to be collected (hereinafter, for convenience sake, also referred to as “particular gutter” in some cases) covers the communication mechanism 30. FIG. 1 illustrates an example of a gutter with three stages, but the number of stages is arbitrarily determined.

The gas in the S1 space also enters the particular gutter among the respective stages of the multistage gutter 24, which covers the communication mechanism 30. There is provided, to each gutter, an exhaust port for causing the gas in the S1 space, which enters the particular gutter, to pass through the particular gutter to flow toward the S2 space, which is described in detail later.

The control portion 40 issues an instruction to the processing liquid supply mechanism (not shown) so as to control supply start or stop of the processing liquid to be supplied, or control the supply amount per unit time of the processing liquid to be supplied. The control portion 40 issues an instruction to the chuck mechanism (not shown) so as to control the support or support release of the substrate 20 with respect to the table 21.

The control portion 40 controls the rotative force of the motor 23, which is transmitted to the table 21 via a drive portion 22. In this manner, the table 21 rotates, or stops its rotation. Further, the control portion 40 also controls the start or stop of the ascending of the table 21, or the start or stop of the descending of the table 21, which is performed by the actuator function provided to the motor 23. The control portion 40 controls the advancing and retracting action of the actuator 26, which is transmitted to the multistage gutter 24 via a transmitting portion 25. In this manner, the multistage gutter 24 starts or stops its ascending, or starts or stops its descending. The control procedure by the control portion 40 is described later.

FIG. 2 is a schematic plan view of the “A-A” portion of the substrate processing apparatus 1 illustrated in FIG. 1. FIG. 2 illustrates an example of a state where the substrate 20 is supported onto the table 21, and the substrate processing apparatus 1 is constructed so as to include the inner barrel member 12 surrounding the table 21, the multistage gutter 24 provided so as to surround the outer circumference of the inner barrel member 12, and the outer barrel member 13 surrounding the multistage gutter 24.

The exhaust duct 27 in FIG. 2 is connected to the exhaust processing portion 50 to be controlled by the control portion 40. The exhaust processing portion 50 sucks the gas in the S2 space via the exhaust duct 27. By sucking the gas in the S2 space, the pressure in the S2 space decreases, which makes the pressure in the S1 space higher than the pressure in the S2 space. As a result, the gas in the S1 space flows through the communication mechanism 30 toward the S2 space, resulting in that the gas in the S1 space is exhausted outside an outer wall of the outer barrel member 13.

The exhaust duct 27 may be provided in parallel to the tangential direction of the outer wall of the outer barrel member 13. When the exhaust of the S2 space is performed via the exhaust duct 27 under this state, an airflow is generated, which rotates along the inner circumference of the outer barrel member 13. The gas in the S2 space is forced to flow by the centrifugal force of the rotating airflow, and thus is efficiently exhausted outside the outer wall of the outer barrel member 13. Further, because the gas in the S2 space is forced to flow and exhausted, the gas in the S1 space also efficiently flows toward the S2 space.

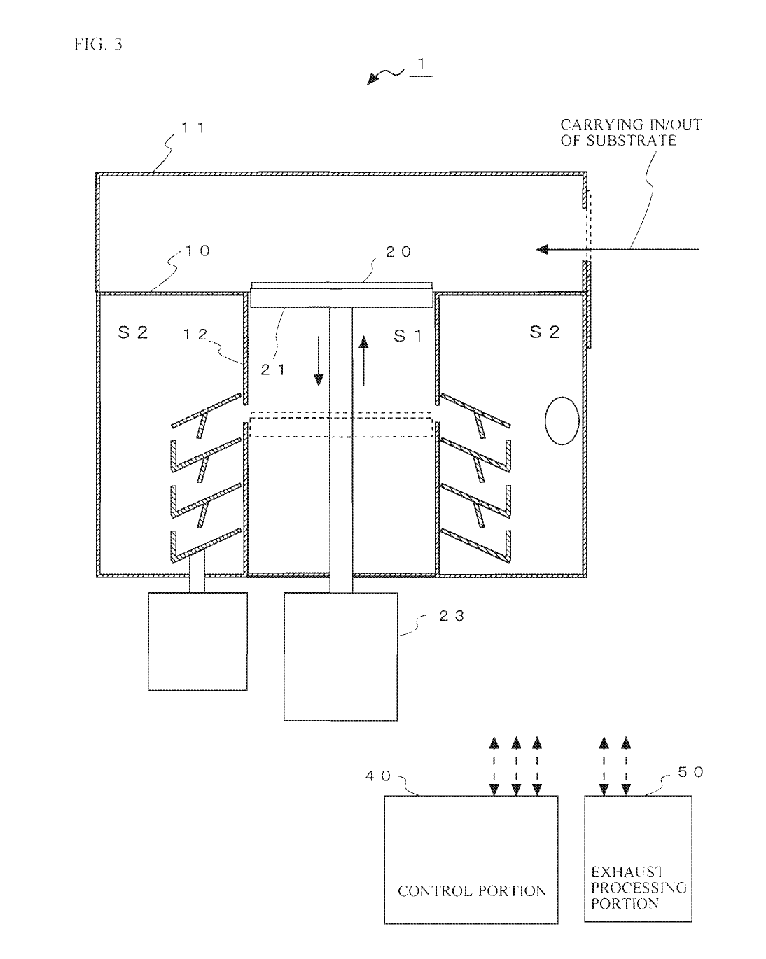

FIG. 3 illustrates an example of a state where the table 21 is stopping at the opening portion of the inner barrel member

The table 21 ascends or descends in response to the instruction of the control portion 40, with the use of the actuator function provided to the motor 23 controlled by the control portion 40.

Here, when the table 21 stops at the opening portion of the inner barrel member 12, the opening portion is “lidded” by the table 21. Under this state, the substrate carrying-in/out port is opened, a carrying-in/out mechanism (not shown) carries the substrate 20 before processing into the processing space. The substrate 20 thus carried-in is supported onto the table 21 by the chuck mechanism (not shown), and then the substrate carrying-in/out port is closed. In addition, also in the case where the substrate 20 after processing is carried out from the processing space, under a state in which the opening portion of the inner barrel member 12 is “lidded” by the table 21, the substrate carrying-in/out port is opened, and the substrate 20 is carried out from the processing space. With this, the carrying-in/out of the substrate 20 can be performed without allowing each gas in the S1 space and the S2 space to leak out to the space surrounded by the top cover 11 from the opening portion of the inner barrel member 12. Further, even when the substrate carrying-in/out port is opened when the substrate 20 is carried in and out, the S1 space and the S2 space are not contaminated.

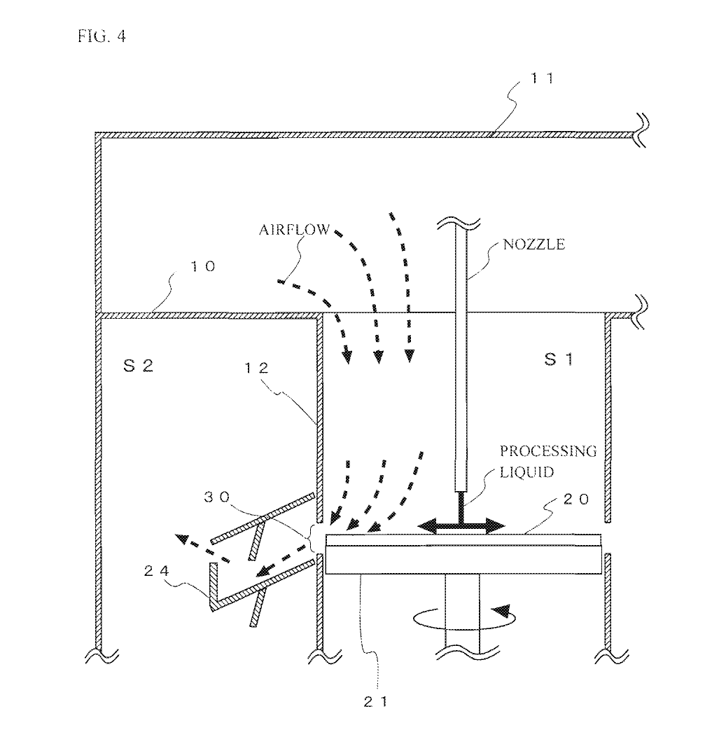

FIG. 4 schematically illustrates a state in which processing is performed onto the processing target surface of the substrate 20 supported onto the table 21, and a state of the airflow at this time. The processing liquid illustrated in FIG. 4 is supplied, with the control by the control portion 40, vertically downward from a nozzle connected to the processing liquid supply mechanism toward the center of the substrate 20 for a predetermined period of time under a state in which the rotating speed of the table 21 has reached a predetermined value. The supplied processing liquid enters from the center of the substrate 20, and is forced to flow by the centrifugal force due to the rotation of the table 21 to diffuse in the outer circumference direction of the substrate 20. The diffused processing liquid reaches the outer circumference of the substrate 20 and is spun off from the processing target surface. The processing liquid thus spun off passes through the communication mechanism 30 to be collected in the particular gutter of the multistage gutter 24 in accordance with the type of the used processing liquid.

The force by the centrifugal force, which enables the processing liquid spun off from the processing target surface to pass through the communication mechanism 30, is set in consideration of the rotating speed of the table 21, and in addition, the force caused by the airflow, a viscosity of the processing liquid, a supply pressure of the processing liquid, an area of the processing target surface of the substrate 20, and the like.

The airflow illustrated in FIG. 4 is generated owing to the synergistic effect of the suction of the gas in the S2 space by the exhaust processing portion 50 and the action of the centrifugal force due to the rotation of the table 21. The airflow is directed from the space surrounded by the top cover 11 to pass through the opening portion of the inner barrel member 12 and flow toward the S1 space. The opening portion of the inner barrel member 12 “narrows” the airflow passing therethrough, and hence the narrowed airflow is forced to flow owing to the Venturi effect.

The airflow forced to flow by passing through the opening portion travels inside the S1 space toward the surface of the table 21. After that, the airflow passes through the communication mechanism 30 to enter the particular gutter of the multistage gutter 24.

The communication mechanism 30 “narrows” the airflow passing therethrough, and hence the narrowed airflow is forced to flow owing to the Venturi effect. The airflow forced to flow by passing through the communication mechanism 30 passes through the entering particular gutter to flow out to the S2 space. With the effect of the airflow thus forced to flow, the mist containing particles or the like generated in the S1 space at the time of processing of the substrate 20 is efficiently exhausted from the S1 space. Further, the mist containing particles or the like adhering to the inner surface of the particular gutter can be also efficiently removed from the inner surface due to the effect of the airflow thus forced to flow.

The airflow can be applied with an adequate force by adjusting, for example, the clean air supply amount per unit time from the clean air supply mechanism (not shown) and the exhaust amount per unit time of the gas in the S2 space by the exhaust processing portion 50.

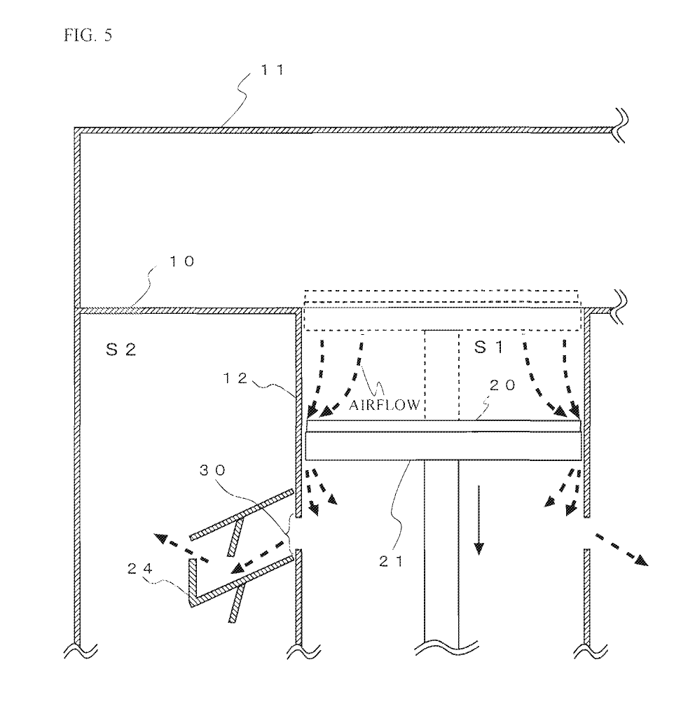

FIG. 5 illustrates an example of a state of the airflow when the table 21 supporting the substrate 20 before processing at the opening portion of the inner barrel member 12 descends.

The control portion 40 issues an instruction to the motor 23 provided with the actuator function so that the table 21 starts its descending. At the time of the descending of the table 21, the control portion 40 issues an instruction to the exhaust processing portion 50 so as to suck the gas in the S2 space so that the gas in the S1 space on the front surface side of the table 21 flows through a gap between the inner wall of the inner barrel member 12 and the outer end surface of the table 21 toward the S1 space on the rear surface side of the table 21. The suction amount per unit time of the gas in the S2 space, which enables forming such a flow, is preset based on, for example, an amount of change in volume of the S1 space on the front surface side of the table 21 and of the S1 space on the rear surface side of the table 21 in accordance with the descending speed of the table 21. The instruction for this suction amount is issued from the control portion 40 to the exhaust processing portion 50.

Further, each pressure in the S1 space on the front surface side of the table 21 and on the rear surface side of the table 21 may be measured by a pressure gauge (not shown), to thereby set the suction amount based on this measurement result so that the pressure in the S1 space on the front surface side of the table 21 becomes higher. The gas flowing toward the S1 space on the rear surface side of the table 21 passes through the communication mechanism 30 to enter the particular gutter of the multistage gutter 24. Then, the gas flows out to the second space.

The gap between the inner wall of the inner barrel member 12 and the outer end surface of the table 21 “narrows” the airflow passing through the gap, and hence the narrowed airflow is forced to flow owing to the Venturi effect. With the effect of the airflow thus forced to flow, the mist containing particles or the like adhering to an inner peripheral surface of the inner barrel member 12 in a range that the table 21 descends is efficiently removed from the inner peripheral surface.

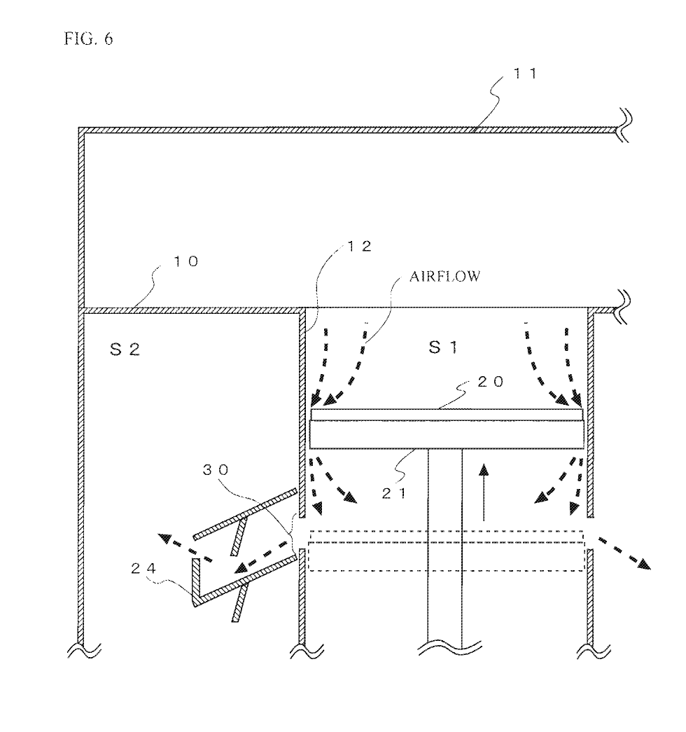

FIG. 6 illustrates an example of a state of the airflow when the table 21 supporting the substrate 20 after processing ascends toward the opening portion of the inner barrel member 12.

The control portion 40 issues an instruction to the motor 23 provided with the actuator function so that the table 21 starts its ascending. Similarly to the above-mentioned case where the table 21 descends, also at the time of the ascending of the table 21, the control portion 40 issues an instruction to the exhaust processing portion 50 so as to suck the gas in the S2 space so that the gas in the S1 space on the front surface side of the table 21 flows through a gap between the inner wall of the inner barrel member 12 and the outer end surface of the table 21 toward the S1 space on the rear surface side of the table 21. The suction amount per unit time of the gas in the S2 space, which enables forming such a flow, is preset based on, for example, an amount of change in volume of the S1 space on the front surface side of the table 21 and of the S1 space on the rear surface side of the table 21 in accordance with the ascending speed of the table 21. The instruction for this suction amount is issued from the control portion 40 to the exhaust processing portion 50. Further, each pressure in the S1 space on the front surface side of the table 21 and on the rear surface side of the table 21 may be measured by a pressure gauge (not shown), to thereby set the suction amount based on this measurement result so that the pressure in the S1 space on the front surface side of the table 21 becomes higher.

The gas flowing into the S1 space on the rear surface side of the table 21 passes through the communication mechanism 30 to enter the particular gutter of the multistage gutter 24. Then, the gas flows out to the second space.

The gap between the inner wall of the inner barrel member 12 and the outer end surface of the table 21 “narrows” the airflow passing through the gap, and hence the narrowed airflow is forced to flow owing to the Venturi effect. With the effect of the airflow thus forced to flow, the mist containing particles or the like adhering to an inner peripheral surface of the inner barrel member 12 in a range that the table 21 ascends is efficiently removed from the inner peripheral surface.

Here, the suction amount of the gas in the S2 space by the exhaust processing portion 50 may be such a level that the gas in the S2 space does not flow into the S1 space by the ascending of the table 21. When the table 21 ascends, the volume of the S1 space on the rear surface side of the table 21 increases to decrease the pressure in the space. As a result, the pressure in the S1 space on the front surface side of the table 21 increases, and the gas in the S1 space on the front surface side of the table 21 flows through the gap between the inner wall of the inner barrel member 12 and the outer end surface of the table 21 toward the S1 space on the rear surface side of the table 21. Thus, it is possible to obtain similar effects as those described above. Further, it is possible to reduce the energy to be used by the exhaust processing portion 50.

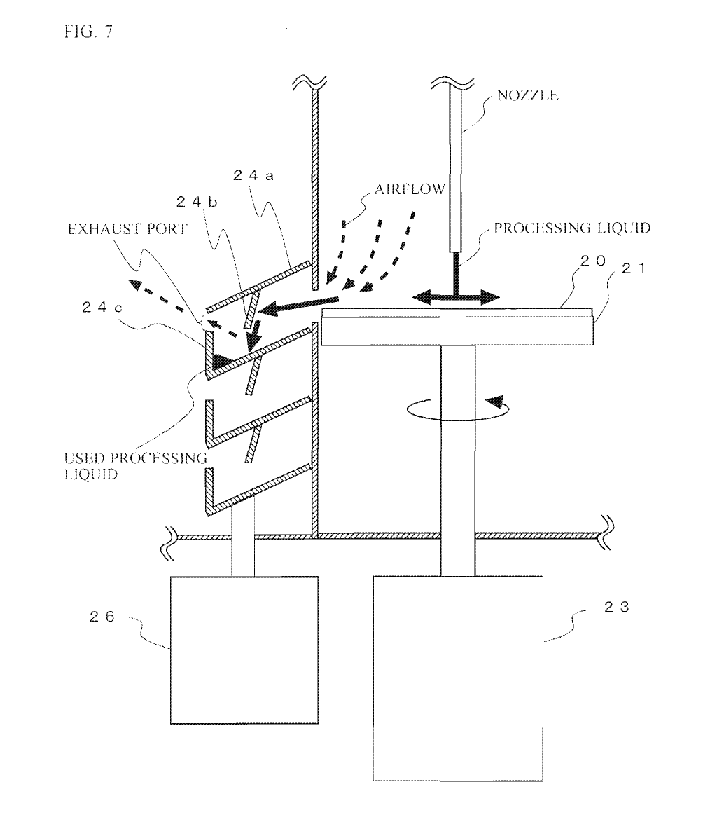

FIG. 7 illustrates an example of a moving state of the processing liquid supplied from the nozzle toward the center of the substrate 20, a state of the airflow, and a state in which the used processing liquid is collected in the particular gutter of the multistage gutter 24. Here, as one example, an example of collecting the used processing liquid in an uppermost stage of the multistage gutter 24 is described.

With the rotative force of the motor 23, the table 21 supporting the substrate 20 rotates, and the processing liquid is supplied from the nozzle under this state. The supplied processing liquid is forced to flow owing to the synergistic effect of the centrifugal force due to the rotation of the table 21 and the airflow, and is diffused from the center of the substrate 20 toward the outer circumference thereof. The processing liquid that has reached the outer circumference of the substrate 20 is spun off from the processing target surface so as to further move toward the communication mechanism 30.

The used processing liquid thus forced to flow and spun off from the processing target surface reaches the communication mechanism 30, and passes through the communication mechanism 30 to enter the particular gutter. Then, the used processing liquid hits onto a barrier wall 24b provided on a top plate 24a of the multistage gutter 24. By hitting onto the barrier wall 24b, the used processing liquid loses its momentum, and due to the action of gravity, the used processing liquid moves downward along the inclination of the barrier wall 24b, to thereby be collected at a collecting portion 24c. The used processing liquid collected at the collecting portion 24c is discharged outside the outer wall of the outer barrel member 13 from the collecting portion 24c via a drain (not shown).

Among the airflow illustrated in FIG. 7, the airflow forced to flow to pass through the communication mechanism 30 enters the particular gutter to flow through the particular gutter, and then hits onto the barrier wall 24b. A part of the mist containing particles or the like contained in the gas loses its momentum by hitting onto the barrier wall 24b, and due to the action of gravity, the mist containing particles or the like is separated from the gas to move downward along the inclination of the barrier wall 24b, to thereby be collected at the collecting portion 24c. The gas hitting onto the barrier wall 24b flows in a space sandwiched between the top plate 24a and the collecting portion 24c while changing its traveling direction, and then flows out to the S2 space from the exhaust port.

Further, the used processing liquid formed into a mist by colliding to the barrier wall 24b does not flow out to the S1 space owing to the airflow directed toward the S2 space through the particular gutter.

By changing the area of the exhaust port provided to each stage of the multistage gutter 24, it is possible to adjust the airflow passing through the communication mechanism 30 so as to be an airflow which is suitably forced to flow in order to remove, from the inner wall of the particular gutter, the mist containing particles or the like adhering to the inner wall.

In this embodiment, description is made of the substrate processing apparatus 1 having a structure including the multistage gutter 24, but the gutter for collecting the used processing liquid may be a gutter having one stage.

Control Procedure for Substrate Processing

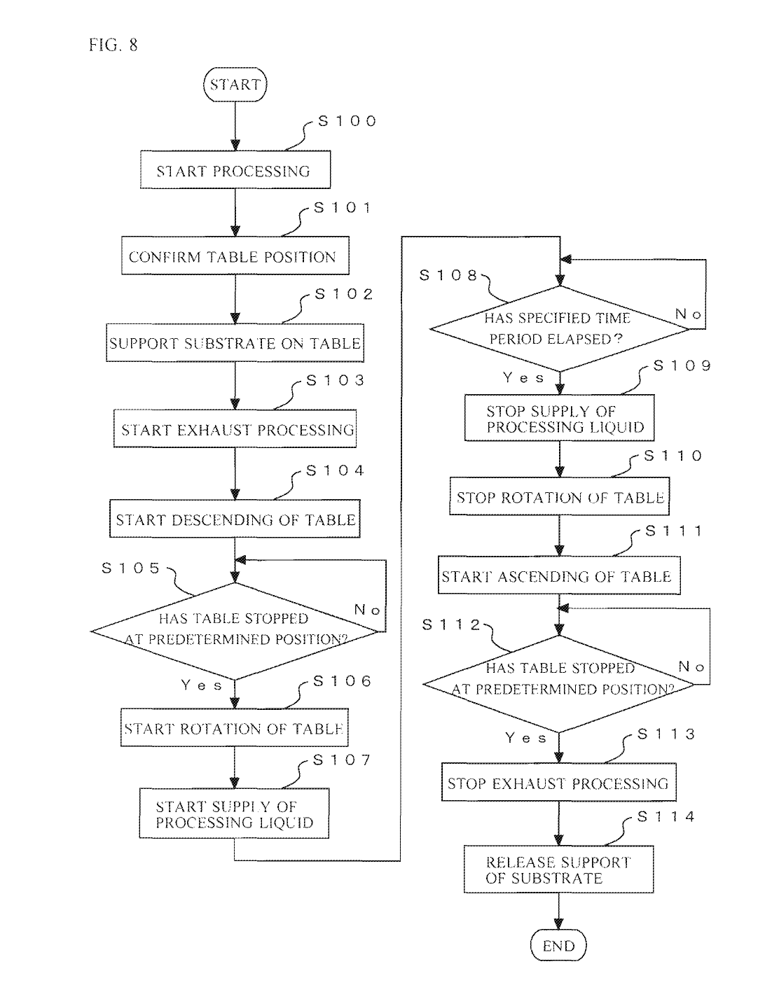

Next, a substrate processing method performed by the substrate processing apparatus 1, particularly, a main control procedure performed by the control portion 40 is described. FIG. 8 is an explanatory flow chart illustrating the control procedure.

The control portion 40 starts the control when receiving input of an instruction to start the substrate processing from an operator operating the substrate processing apparatus 1 (Step S100). The control portion 40 detects that the table 21 is stopped at the opening portion of the inner barrel member 12 in order to receive the substrate from the carrying-in/out mechanism (not shown) (Step S101). Then, the chuck control mechanism is activated to horizontally support the substrate 20 at a predetermined part of the table 21 (Step S102).

When the control portion 40 detects that the substrate 20 has been supported and the substrate carrying-in/out port has been closed, the control portion 40 activates the exhaust processing portion 50 and issues an instruction of exhaust start (Step S103).

The control portion 40 activates the motor 23. The motor 23 starts, in response to the instruction from the control portion 40, the descending of the table 21 with the use of the actuator function provided to the motor 23 (Step S104).

When a sensor (first sensor) (not shown) detects that the table 21 has descended to a predetermined position, the control portion 40 issues an instruction to the motor 23 so as to stop the descending of the table 21, and when it is detected that the descending of the table 21 has stopped (Step S105: Yes), the control portion 40 issues an instruction to the motor 23 so as to start the rotation of the table (Step S106). With this, the table 21 starts its rotation horizontally.

The control portion 40 activates the actuator 26. In response to the instruction from the control portion 40, the actuator 26 causes the multistage gutter 24 to ascend or descend so that the particular gutter covers the communication mechanism 30 from the outer wall side of the inner barrel member 12.

When a timer (not shown) detects that a specified time period (first time period) has elapsed after the instruction to start the rotation of the table 21 is issued, the control portion 40 issues an instruction for positioning of the nozzle and an instruction to start supply of the processing liquid to the processing liquid supplymechanism (not shown) (Step S107). With this, the processing liquid is supplied from the nozzle toward the center of the processing target surface of the substrate 20.

When the timer detects that a specified time period (second time period) has elapsed after the instruction to start the supply of the processing liquid is issued, the control portion 40 issues an instruction to the processing liquid supply mechanism so as to stop the supply of the processing liquid (Step S108: Yes). With the supply stop of the processing liquid, the processing liquid remaining on the processing target surface of the substrate 20 on the table 21 is removed outside the table 21. In this manner, the drying processing is performed.

When the timer detects that a further specified time period (third time period) has elapsed, the control portion 40 issues a stop instruction to the motor 23 so as to stop the rotation of the table 21 (Step S110). When it is detected that the motor 23 has stopped, the control portion 40 issues an instruction to the motor 23 so as to start the ascending of the table 21 with the use of the actuator function provided to the motor 23 (Step S111). When a sensor (second sensor) (not shown) detects that the table 21 has ascended up to the opening portion of the inner barrel member 12, the control portion 40 issues an instruction to the motor 23 so as to stop the ascending of the table 21, and when it is detected that the ascending of the table 21 has stopped (Step S112: Yes), the control portion 40 issues an instruction to the exhaust processing portion 50 so as to stop the exhaust (Step S113). In order to enable the carrying-in/out mechanism (not shown) to carry out the substrate 20 that has been subjected to processing, the control portion 40 issues an instruction to the chuck control mechanism (not shown) so as to release the support of the substrates 20 (Step S114). With this, the surface processing of the substrates 20 is completed.

Here, a procedure of a case where a plurality of types of the processing liquid are used in one substrate processing is described.

Even after a specified time period (third time period) has elapsed, the control portion 40 maintains the rotation of the table 21. Under a preset condition, the control portion 40 activates the actuator 26 in order to collect the used processing liquid in a particular gutter corresponding to the processing liquid to be supplied next, and in response to the instruction from the control portion 40, the actuator 26 causes the multistage gutter 24 to ascend or descend so that the particular gutter covers the communication mechanism 30 from the outer wall side of the inner barrel member. When a sensor (third sensor) (not shown) detects that the multistage gutter 24 has stopped at a predetermined position, the control portion 40 issues an instruction to the processing liquid supply mechanism (not shown) so as to start supply of the processing liquid (Step S107).

The control portion 40 repeatedly issues such an instruction when supplying a processing liquid of a different type from that of the processing liquid used in the latest processing. In this manner, the used processing liquid of different types can be separately collected.

Further, when the control portion 40 issues an instruction to the exhaust processing portion 50 so as to start or stop the exhaust, the clean air supply mechanism (not shown) may start or stop the supply of clean air in association therewith. For example, when the control portion 40 issues an instruction of exhaust start, the supply of the clean air also starts, or when the control portion 40 issues an instruction of exhaust stop, the supply of the clean air also stops. In this manner, when the substrate 20 is carried in and out, it is possible to prevent the gas in the space surrounded by the top cover 11 from flowing out from the substrate carrying-in/out port.

As described above, in the substrate processing apparatus 1, when the gas in the S1 space flows through the communication mechanism 30 toward the S2 space, the airflow passing through the opening portion of the inner barrel member 12 and the communication mechanism 30 is forced to flow, and owing to the airflow thus forced to flow, the gas in the S1 space is efficiently exhausted outside the outer wall of the outer barrel member 13. Therefore, the substrate is prevented from being contaminated by the mist containing particles or the like generated when the substrate 20 is subjected to processing.

There is a gap between the outer end surface of the table 21 and the inner wall of the inner barrel member 12, and the gas in the S1 space flows from the front surface side of the table 21 toward the rear surface side of the table 21. At this time, the gap “narrows” the airflow, and hence owing to the Venturi effect, the airflow is further forced to flow. With this, it is possible to efficiently remove, from the inner wall of the inner barrel member 12, the mist containing particles or the like adhering to the inner wall in a range that the table 21 ascends or descends, to thereby prevent deposition of the adhering mist.

Further, owing to the synergistic effect of the centrifugal force due to the rotation of the table 21 and the airflow forced to flow, the processing liquid is immediately discharged outside the table 21, and hence the “cutoff” of the processing liquid is improved, which makes it possible to rapidly complete the drying processing.

Still further, by forming the chamber 10, the top cover 11, and the like of a translucent member to enable visual observation of the processing status of the substrate 20 from the exterior appearance of the chamber 10, it is possible to rapidly discover the apparatus failure occurring in the middle of the substrate processing, or the breakage of the substrate during processing.

Yet further, it is possible to gradually reduce the pressure in the respective spaces in the order of the space surrounded by the top cover 11, the S1 space, and the S2 space, and hence the gas in the processing space is not randomly dispersed outside the processing space. With this, it is possible to prevent adverse effects on human health due to the gas in the processing space, and corrosion of the equipped components of the substrate processing apparatus. Further, by forming the processing space in a compact size, the airflow in the processing space is prevented from being disturbed, which makes it possible to prevent gas diffusion more efficiently. Further, in a case where a gas (for example, helium gas) is used when the substrate processing is performed, owing to the synergistic effect with “lidding” the opening portion of the inner barrel member 12 by the table 21, the gas diffusion can be suppressed.

### Second Embodiment

Here, description is made of an embodiment of a substrate processing apparatus in which, in the substrate processing apparatus 1, it is possible to additionally perform exhaust of the space surrounded by the top cover 11, and to limit or block the gas passing through the communication mechanism 30 by blocking a part or the whole of the communication mechanism 30.

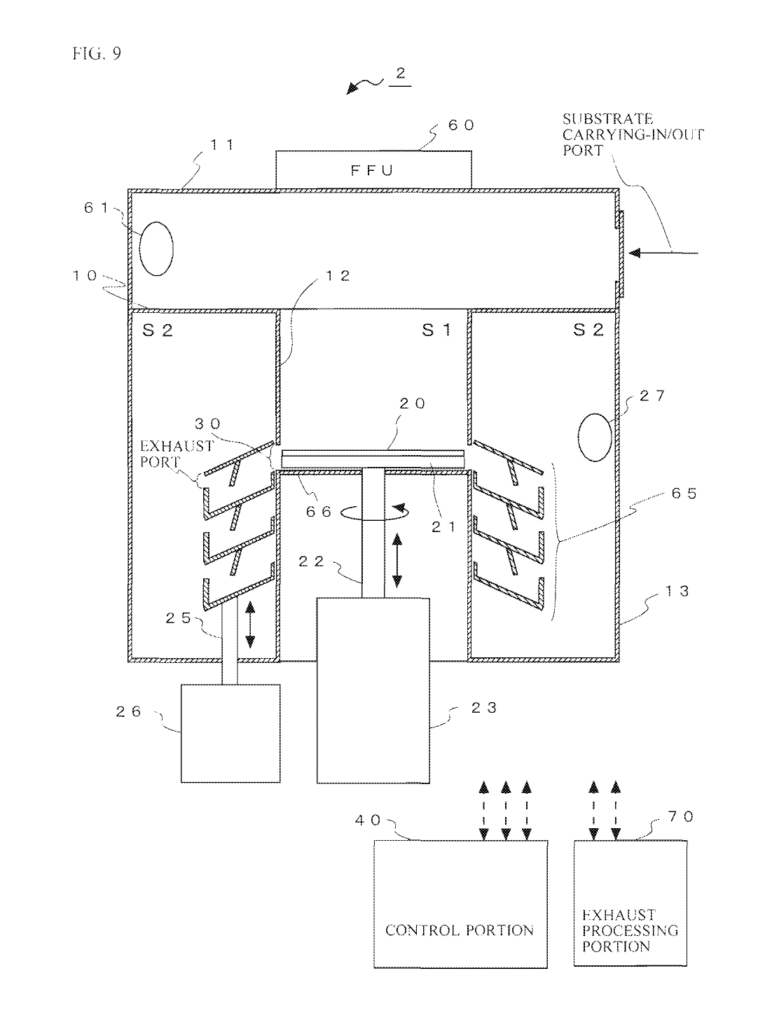

FIG. 9 is a schematic vertical sectional view illustrating a structural example of periphery members of a substrate processing apparatus 2 according to a second embodiment of the present invention. Further, overlapping portions as those described in the first embodiment are denoted by the same reference symbols, and overlapping description thereof is omitted. The substrate processing apparatus 2 of this embodiment additionally includes a fan filter unit (FFU) 60 and a top cover exhaust duct 61. A multistage gutter 65, a bottom plate 66, and an exhaust processing portion 70 are portions which are different from the first embodiment.

The FFU 60 blows out cleaned air toward the space surrounded by the top cover 11. By sucking the gas in the S2 space, the cleaned air blown out from the FFU 60 flows from the space surrounded by the top cover 11 into the S1 space, and flows from the S1 space through the communication mechanism 30 and a particular gutter of the multistage gutter 65, and thus flows out to the S2 space. Along with the movement of the cleaned air in the respective spaces, a mist of the used processing liquid which has been used for processing of the substrate 20, a mist containing particles, the used processing liquid formed into a gas, and the like (hereinafter, for convenience sake, simply referred to as “gas” in some cases) are taken into the cleaned air.

In the outer peripheral surface of the top cover 11, the top cover exhaust duct 61 is provided, which is described in detail later.

The multistage gutter 65 includes a plurality of stages which are separately arranged in a stacking manner so that a plurality of types of the used processing liquid, which have been used for processing of the substrate 20, can be collected without being mixed with each other. FIG. 9 illustrates an example in which three stages of gutters are stacked to form an integral shape. In the multistage gutter 65, the particular gutter corresponding to the type of the used processing liquid to be collected collects the used processing liquid. Therefore, the multistage gutter 65 ascends or descends by being controlled by the control portion 40 so that the particular gutter covers the communication mechanism 30 from the outer wall side of the inner barrel member 12. The gas in the S1 space also enters the particular gutter of the multistage gutter 65 covering the communication mechanism 30. Therefore, in order to cause the gas in the S1 space entering the gutter to pass through the gutter and flow out to the S2 space, an exhaust port is provided to each gutter, which is described in detail later.

The bottom plate 66 is provided to the inner barrel member 12 so as to be opposed, with a predetermined gap, to the rear surface of the table 21 at a place where the table 21 stops its descending for processing of the substrate 20. The predetermined gap is, for example, about 5 mm. The space surrounded by the top cover 11, and the first space (S1 space), which is surrounded by the inner barrel member 12 and the bottom plate 66 and includes the communication mechanism 30 and the table 21, are the main processing space of the substrate processing apparatus 2.

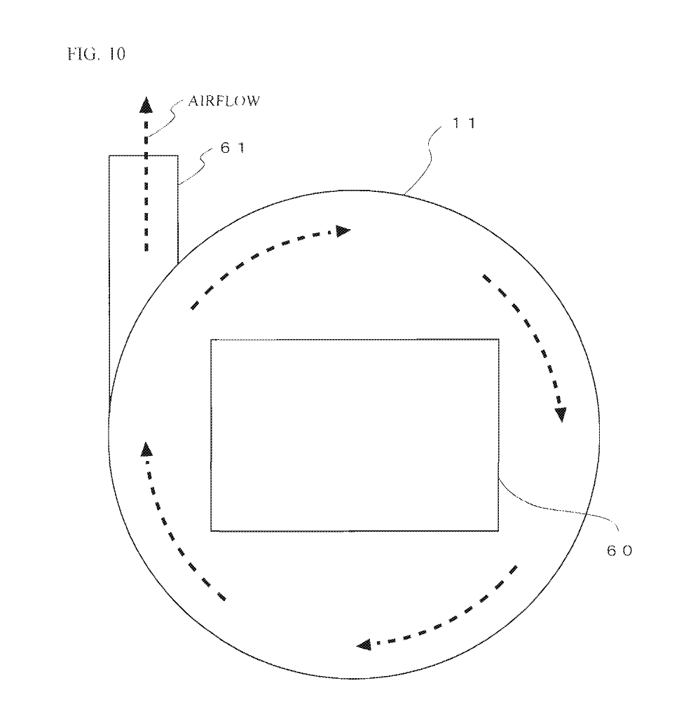

FIG. 10 is a schematic plan view of the substrate processing apparatus 2. The top cover exhaust duct 61 in FIG. 10 is connected to the exhaust processing portion 70 to be controlled by the control portion 40. The exhaust processing portion 70 sucks the gas in the space surrounded by the top cover 11 via the top cover exhaust duct 61.

Further, the top cover exhaust duct 61 may be provided in parallel to the tangential direction of the outer wall of the top cover 11. When the air in the space surrounded by the top cover 11 is exhausted via the top cover exhaust duct 61, an airflow rotating along the inner circumference of the top cover 11 is generated. The gas in the space surrounded by the top cover 11 is forced to flow by the centrifugal force of the rotating airflow, to thereby be efficiently exhausted.

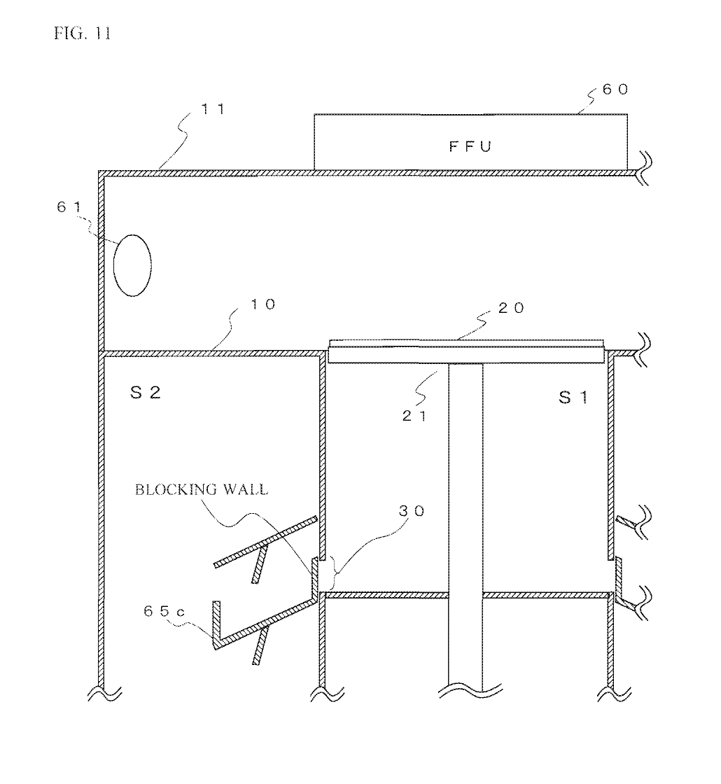

FIG. 11 illustrates an example of a state in which the table 21 is stopping at the opening portion of the inner barrel member 12. To a collecting portion 65c provided to the multistage gutter 65, for collecting the used processing liquid, there is provided a blocking wall for blocking a part or the whole of the communication mechanism 30 from the outer wall side of the inner barrel member 12. The blocking wall blocks a part of the communication mechanism 30 from the outer wall side of the inner barrel member 12, to thereby limit the passing of the gas in the S1 space through the communication mechanism 30. Further, the blocking wall blocks the whole of the communication mechanism 30, to thereby block the passing of the gas in the S1 space through the communication mechanism 30. The blocking wall is provided to the collecting portion 65c in a predetermined shape. The predetermined shape refers to, for example, a band shape having a width capable of covering the communication mechanism 30 from the outer wall side of the inner barrel member 12 and surrounding the outer wall of the inner barrel member 12.

The actuator 26 to be controlled by the control portion 40 causes, in response to the instruction from the control portion 40, the multistage gutter 65 to start or stop its ascending or start or stop its descending. As described in the first embodiment, the substrate 20 before processing or the substrate 20 after processing is carried into or out from the processing space under a state in which the table 21 is stopped at the opening portion of the inner barrel member 12. When the substrate carrying-in/out port is opened in order to carry in or out the substrate 20, the control portion 40 issues an instruction to the actuator 26 so as to cause the multistage gutter 65 to ascend or descend, to thereby block the whole of the communication mechanism 30 by the blocking wall. By blocking the whole of the communication mechanism 30, the gas in the S2 space does not flow from the S2 space through the communication mechanism 30 out to the S1 space.

In this manner, it is possible to more reliably prevent the gas in the S2 space from flowing out from the opening portion of the inner barrel member 12 that is “lidded” by the table 21.

Further, for example, when the substrate carrying-in/out port is opened, the gas in the space surrounded by the top cover 11 is sucked by the exhaust processing portion 70 under the state in which the whole of the communication mechanism 30 is blocked. With this, it is possible to more reliably prevent the gas in the processing space from flowing outside the processing space.

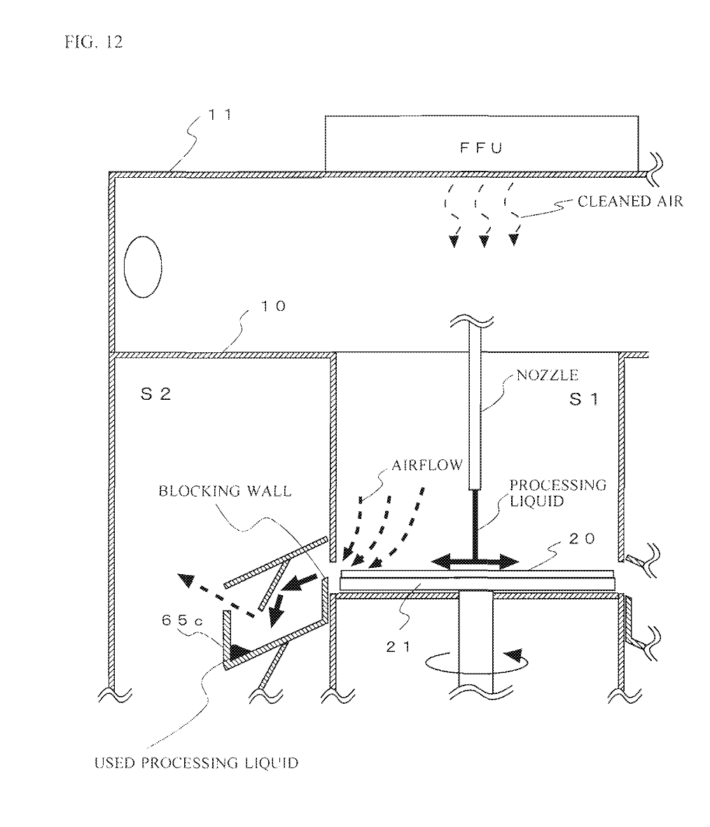

FIG. 12 illustrates an example of a moving state of the processing liquid supplied from the nozzle toward the center of the substrate 20, a state of the airflow, a state in which the used processing liquid is collected by the multistage gutter 65, and a state in which a part of the communication mechanism 30 is blocked by the blocking wall. In FIG. 12, as one example, the used processing liquid is collected in an uppermost stage of the multistage gutter 65.

When the table 21 supporting the substrate 20 is rotated and the processing liquid is supplied from the nozzle under this state, the processing liquid is forced to flow owing to the synergistic effect of the centrifugal force due to the rotation of the table 21 and the airflow, and is diffused from the center of the substrate 20 toward the outer circumference thereof. The processing liquid that has reached the outer circumference of the substrate 20 is spun off from the processing target surface so as to move toward the communication mechanism 30. The used processing liquid thus forced to flow and spun off from the processing target surface reaches the communication mechanism 30, and passes through the communication mechanism 30 to enter the particular gutter and be collected.

The force to be applied to the airflow passing through the communication mechanism 30 may be adjusted by changing the percentage of the communication mechanism 30 blocked by the blocking wall, which is performed by causing the multistage gutter 65 to ascend or descend in response to an instruction issued by the control portion 40 to the actuator 26. Specifically, for example, by increasing the area of the communication mechanism 30 blocked by the blocking wall, the force to be applied to the airflow passing through the communication mechanism 30 can be increased, or by decreasing the area of the communication mechanism 30 blocked by the blocking wall, the force to be applied to the airflow passing through the communication mechanism 30 can be decreased. The force to be applied to the airflow can be arbitrarily changed. Therefore, for example, in a case where a plurality of types of the processing liquid having different viscosities are used in one substrate processing, or in a case where the supply pressure of the processing liquid to be supplied from the nozzle is changed, it is possible to adjust the time period for which the processing liquid stays on the processing target surface of the substrate 20, which makes it easier to produce a suitable processing condition.

As described above, in the substrate processing apparatus 2, when the substrate 20 is carried in and out, the whole of the communication mechanism 30 is blocked by the blocking wall from the outer wall side of the inner barrel member 12, to thereby prevent the gas in the S2 space from flowing out to the S1 space. With this, it is possible to more reliably prevent the gas in the S2 space from flowing out from the opening portion of the inner barrel member 12 that is “lidded” by the table 21.

Further, by changing the area of the communication mechanism 30 blocked by the blocking wall, the force to be applied to the airflow passing through the communication mechanism 30 can be changed. With this, even when the characteristics of the processing liquid to be used vary, setting is possible so that results of processing the substrate 20 become uniform.

Specifically, for example, when the viscosity of the processing liquid to be used is high, the percentage of the communication mechanism 30 blocked by the blocking wall is increased to greatly narrow the airflow passing therethrough, to thereby improve the “cutoff” when the processing liquid is spun off at the outer circumference of the processing target surface of the substrate 20.

Another specific example is as follows. For example, the supplied processing liquid is also forced to flow on the processing target surface by the airflow, and hence, when the processing liquid is supplied to perform processing on the processing target surface of the substrate 20, the force to be applied to the airflow may be decreased so that the processing liquid stays on the processing target surface for a time period required thereto, and when the supply of the processing liquid is stopped to perform drying processing, the force to be applied to the airflow may be increased to perform rapid drying processing.

Further, when a plurality of types of substrates having different thicknesses are to be subjected to processing without changing the communication mechanism 30, such processing can be performed by adjusting the stopping place of the table 21, at which the table 21 supporting the substrate 20 stops its descending to start the processing of the substrate 20, and the percentage of the communication mechanism 30 blocked by the blocking wall. Specifically, for example, when the substrate 20 which is smaller in thickness than a reference substrate is to be subjected to processing, the stopping place of the table 21 is set relatively high to enable the blocking wall to block the communication mechanism 30 so that a necessary force is to be applied to the airflow, which makes the processing possible. Further, when the substrate which is larger in thickness than the reference substrate is to be subjected to processing, the stopping place of the table 21 is set relatively low to enable the blocking wall to block the communication mechanism 30 so that a necessary force is to be applied to the airflow, which makes the processing possible.

Further, it is needless to say that, instead of the multistage gutter 24 included in the substrate processing apparatus 1 described in the first embodiment, the multistage gutter 65 of this embodiment can be used. Further, in this embodiment, description is made of an example of the multistage gutter 65 having a shape in which three stages of gutters are stacked, but a one-stage gutter may be alternatively used.

### Modified Example

(1) The substrate processing apparatus 1 described in the first embodiment may further include the top cover exhaust duct 61 and the exhaust processing portion 70 described in this embodiment. In this case, for example, in the processing step of the substrate 20, the exhaust processing portion 50 keeps sucking the gas in the S2 space without a stop. When the table 21 is stopping at the opening portion of the inner barrel member 12, the exhaust processing portion 70 sucks the gas in the space surrounded by the top cover 11 via the top cover exhaust duct. With this, it is possible to more reliably prevent the gas in the processing space from flowing outside the processing space. (2) It is also possible to provide an exhaust duct to the bottom plate 66 of the substrate processing apparatus 2 of the second embodiment, and cause an exhaust processing mechanism (not shown) to suck the gas in the S1 space via the exhaust duct. With this, the gas in the S1 space on the rear surface side of the table 21 is exhausted, and hence the contamination of the processing target surface of the substrate 20 is more reliably prevented. Further, the removal of the mist containing particles or the like adhering to the inner wall of the inner barrel member 12 due to the ascending or descending of the table 21 is realized by blocking the whole of the communication mechanism 30 by the blocking wall and sucking the gas in the S1 space by the exhaust processing mechanism (not shown) via the exhaust duct provided in the bottom plate 66.

What is claimed is:

1. A substrate processing apparatus, comprising:
a bottomed double barrel member comprising an inner barrel member and an outer barrel member, the inner barrel member including a first space in which a substrate to be subjected to processing is to be arranged;
exhaust means for exhausting a gas in a second space surrounded by an outer wall of the inner barrel member and an inner wall of the outer barrel member outside an outer wall of the outer barrel member from the second space;
a communication mechanism which is formed in a predetermined part of the inner barrel member, for communicating the first space and the second space with each other;
a table for horizontally supporting the substrate on a front surface side thereof inside the first space in the inner barrel member so that a front surface side of the substrate becomes a processing target; and
table ascending/descending means for causing the table to move so that the table freely ascends and descends in the first space,
wherein the exhaust means exhausts the gas in the second space outside the outer wall of the outer barrel member from the second space to decrease a pressure in the second space so that a pressure in the first space becomes higher than the pressure in the second space, thereby forcing a gas in the first space to flow when flowing through the communication mechanism toward the second space, the gas in the first space flowing through a gap between an outer end surface of the table, which one of ascends and descends in the first space, and an inner wall of the inner barrel member, the gas in the first space being forced to flow when flowing from the front surface side of the table to a rear surface side of the table so as to pass through the gap.

2. A substrate processing apparatus according to claim 1, wherein:
the table is disposed inside the inner barrel member so as to be rotatable in parallel to a processing target surface of the substrate under a state in which the processing target surface is exposed to the first space;
the substrate is one of supported onto and released from the table under a state in which the table is stopped at an opening portion of the inner barrel member; and
the table ascending/descending means causes the table supporting the substrate before the processing to descend from the opening portion of the inner barrel member and then causes the table to stop the descending, and further, causes the table supporting the substrate after the processing to ascend up to the opening portion of the inner barrel member and then causes the table to stop the ascending.

3. A substrate processing apparatus according to claim 1, wherein:
the exhaust means exhausts the gas in the second space outside the outer wall of the outer barrel member via an exhaust duct provided in the outer wall of the outer barrel member in parallel to a tangential direction of the outer wall of the outer barrel member; and
when the exhaust means exhausts the gas in the second space outside the outer wall of the outer barrel member, the exhaust duct generates an airflow rotating along the inner wall of the outer barrel member, and the gas in the second space is forced to flow by the airflow, to thereby be exhausted outside the outer wall of the outer barrel member.

4. A substrate processing apparatus according to claim 2, wherein:
the exhaust means exhausts the gas in the second space outside the outer wall of the outer barrel member via an exhaust duct provided in the outer wall of the outer barrel member in parallel to a tangential direction of the outer wall of the outer barrel member; and
when the exhaust means exhausts the gas in the second space outside the outer wall of the outer barrel member, the exhaust duct generates an airflow rotating along the inner wall of the outer barrel member, and the gas in the second space is forced to flow by the airflow, to thereby be exhausted outside the outer wall of the outer barrel member.

5. A substrate processing apparatus according to claim 1, further comprising a gutter provided in the second space, for collecting a used processing liquid that has been used for the processing of the substrate and has passed through the communication mechanism, the gutter covering the communication mechanism from the outer wall side of the inner barrel member, wherein:
the gutter is provided with a blocking wall for blocking one of a part and a whole of the communication mechanism from the outer wall side of the inner barrel member, to thereby limit the passing of the gas in the first space through the communication mechanism; and
the substrate processing apparatus further comprises gutter ascending/descending means for causing the gutter to one of ascend and descend along the outer wall of the inner barrel member so that the blocking wall blocks the one of the part and the whole of the communication mechanism.

6. A substrate processing apparatus according to claim 2, further comprising a gutter provided in the second space, for collecting a used processing liquid that has been used for the processing of the substrate and has passed through the communication mechanism, the gutter covering the communication mechanism from the outer wall side of the inner barrel member, wherein:
the gutter is provided with a blocking wall for blocking one of a part and a whole of the communication mechanism from the outer wall side of the inner barrel member, to thereby limit the passing of the gas in the first space through the communication mechanism; and
the substrate processing apparatus further comprises gutter ascending/descending means for causing the gutter to one of ascend and descend along the outer wall of the inner barrel member so that the blocking wall blocks the one of the part and the whole of the communication mechanism.

7. A substrate processing apparatus according to claim 3, further comprising a gutter provided in the second space, for collecting a used processing liquid that has been used for the processing of the substrate and has passed through the communication mechanism, the gutter covering the communication mechanism from the outer wall side of the inner barrel member, wherein:
the gutter is provided with a blocking wall for blocking one of a part and a whole of the communication mechanism from the outer wall side of the inner barrel member, to thereby limit the passing of the gas in the first space through the communication mechanism; and
the substrate processing apparatus further comprises gutter ascending/descending means for causing the gutter to one of ascend and descend along the outer wall of the inner barrel member so that the blocking wall blocks the one of the part and the whole of the communication mechanism.

8. A substrate processing apparatus according to claim 4, further comprising a gutter provided in the second space, for collecting a used processing liquid that has been used for the processing of the substrate and has passed through the communication mechanism, the gutter covering the communication mechanism from the outer wall side of the inner barrel member, wherein:
the gutter is provided with a blocking wall for blocking one of a part and a whole of the communication mechanism from the outer wall side of the inner barrel member, to thereby limit the passing of the gas in the first space through the communication mechanism; and
the substrate processing apparatus further comprises gutter ascending/descending means for causing the gutter to one of ascend and descend along the outer wall of the inner barrel member so that the blocking wall blocks the one of the part and the whole of the communication mechanism.

9. A substrate processing apparatus according to claim 5, wherein:
the gutter is provided with a barrier wall for reducing a moving speed of the used processing liquid entering the gutter and moving through the gutter; and
the used processing liquid entering the gutter and moving through the gutter hits onto the barrier wall to slow down and be collected by the gutter, and further, the gas in the first space entering the gutter passes through the gutter to flow out to the second space.

10. A substrate processing apparatus according to claim 6, wherein:
the gutter is provided with a barrier wall for reducing a moving speed of the used processing liquid entering the gutter and moving through the gutter; and
the used processing liquid entering the gutter and moving through the gutter hits onto the barrier wall to slow down and be collected by the gutter, and further, the gas in the first space entering the gutter passes through the gutter to flow out to the second space.

11. A substrate processing apparatus according to claim 7, wherein:
the gutter is provided with a barrier wall for reducing a moving speed of the used processing liquid entering the gutter and moving through the gutter; and
the used processing liquid entering the gutter and moving through the gutter hits onto the barrier wall to slow down and be collected by the gutter, and further, the gas in the first space entering the gutter passes through the gutter to flow out to the second space.

12. A substrate processing apparatus according to claim 8, wherein:
the gutter is provided with a barrier wall for reducing a moving speed of the used processing liquid entering the gutter and moving through the gutter; and
the used processing liquid entering the gutter and moving through the gutter hits onto the barrier wall to slow down and be collected by the gutter, and further, the gas in the first space entering the gutter passes through the gutter to flow out to the second space.

13. A substrate processing apparatus according to claim 9, wherein:
the gutter for collecting the used processing liquid comprises a plurality of stages in an ascending and descending direction so that a plurality of types of the used processing liquid, which have been used for the processing of the substrate, are independently collected; and
the gutter ascending/descending means causes the gutter to one of ascend and descend along the outer wall of the inner barrel member so that, in order to collect different types of the used processing liquid in the respective plurality of stages, a stage corresponding to the used processing liquid to be collected covers the communication mechanism.

14. A substrate processing apparatus according to claim 10, wherein:
the gutter for collecting the used processing liquid comprises a plurality of stages in an ascending and descending direction so that a plurality of types of the used processing liquid, which have been used for the processing of the substrate, are independently collected; and
the gutter ascending/descending means causes the gutter to one of ascend and descend along the outer wall of the inner barrel member so that, in order to collect different types of the used processing liquid in the respective plurality of stages, a stage corresponding to the used processing liquid to be collected covers the communication mechanism.

15. A substrate processing apparatus according to claim 11, wherein:
the gutter for collecting the used processing liquid comprises a plurality of stages in an ascending and descending direction so that a plurality of types of the used processing liquid, which have been used for the processing of the substrate, are independently collected; and
the gutter ascending/descending means causes the gutter to one of ascend and descend along the outer wall of the inner barrel member so that, in order to collect different types of the used processing liquid in the respective plurality of stages, a stage corresponding to the used processing liquid to be collected covers the communication mechanism.

16. A substrate processing apparatus according to claim 12, wherein:
the gutter for collecting the used processing liquid comprises a plurality of stages in an ascending and descending direction so that a plurality of types of the used processing liquid, which have been used for the processing of the substrate, are independently collected; and
the gutter ascending/descending means causes the gutter to one of ascend and descend along the outer wall of the inner barrel member so that, in order to collect different types of the used processing liquid in the respective plurality of stages, a stage corresponding to the used processing liquid to be collected covers the communication mechanism.

17. A substrate processing apparatus according to claim 1, wherein the bottomed double barrel member is formed of a translucent member to enable visual observation of a processing status of the substrate from an exterior appearance of the bottomed double barrel member.

18. A substrate processing apparatus according to claim 2, wherein the bottomed double barrel member is formed of a translucent member to enable visual observation of a processing status of the substrate from an exterior appearance of the bottomed double barrel member.

19. A substrate processing apparatus according to claim 3, wherein the bottomed double barrel member is formed of a translucent member to enable visual observation of a processing status of the substrate from an exterior appearance of the bottomed double barrel member.

20. A substrate processing method for a substrate processing apparatus capable of exhausting a gas in a processing space for performing processing of a substrate, the substrate processing apparatus including a bottomed double barrel member including an inner barrel member and an outer barrel member, the inner barrel member including a first space in which the substrate to be subjected to the processing is to be arranged, the substrate processing method comprising:
exhausting, by exhaust means, a gas in a second space surrounded by an outer wall of the inner barrel member and an inner wall of the outer barrel member outside an outer wall of the outer barrel member from the second space, to thereby decrease a pressure in the second space so that a pressure in the first space in the inner barrel member becomes higher than the pressure in the second space; and
forcing a gas in the first space to flow when flowing through a communication mechanism toward the second space, the communication mechanism being formed in a predetermined part of the inner barrel member, for communicating the first space and the second space with each other, the gas in the first space flowing, when a table for horizontally supporting the substrate on a front surface side thereof inside the first space in the inner barrel member so that a front surface side of the substrate becomes a processing target one of ascends and descends in the first space by table ascending/descending means, through a gap between an outer end surface of the table and an inner wall of the inner barrel member, the gas in the first space being forced to flow when flowing from the front surface side of the table to a rear surface side of the table so as to pass through the gap.
